(19) United States
(12) Patent Application Publication
(10) Pub. No.: US 2014/0122133 A1
(43) Pub. Date: May 1, 2014

(54) METHOD OF VIRTUALLY SETTLING INSURANCE CLAIMS

(71) Applicant: BODYSHOPBIDS, INC., Chicago, IL (US)

(72) Inventors: Brad Weisberg, Chicago, IL (US); Clifford Przybyl, Lake Zurich, IL (US)

(21) Appl. No.: 13/938,512

(22) Filed: Jul. 10, 2013

Related U.S. Application Data
(60) Provisional application No. 61/720,720, filed on Oct. 31, 2012.

(51) Int. Cl. G06Q 40/08

(52) U.S. Cl. CPC G06Q 40/08
USPC 705/4

(57) ABSTRACT

A method of virtually settling insurance claims includes the steps of transmitting notice of damage to property of an insured to an insurer through a computer network and providing a claim assignment from the insurer to an intermediary claim manager through the computer network. The method further includes providing the insured with an application through the computer network from the intermediary claim manager, the application configured to be downloaded on a device of the insured and facilitating the transmission of claim information to the intermediary claim manager through the computer network, transmission of claim information through the computer network to the intermediary claim manager for generating a claim assessment by the intermediary claim manager, the claim assessment including at least one settlement option for the insured; and transmitting the claim assessment through the computer network to the insurer.

This application claims priority to U.S. Provisional Patent Application Ser. No. 61/720,720 filed Oct. 31, 2012, hereby incorporated herein by reference in its entirety.

### FIELD OF THE INVENTION

The present invention relates to a method of virtually settling insurance claims using an intermediary between the insured and the insurer to facilitate a claim settlement process.

### BACKGROUND OF THE INVENTION

A requirement for filing a claim with an insurance company or insurer is that a professional repair estimate for damaged property or vehicles must be provided to the insurer for every insurance claim filed. Insurers often have on-staff appraisers that obtain repair estimates for the damaged property or damaged vehicle of an insured customer or claimant. The appraiser will typically request that the insured either obtain estimates from multiple repair sources or the appraiser will schedule an appointment with the insured to assess the damage of the property or vehicle and collect pertinent information specific to the insurance claim. During the appointment, the appraiser typically takes photographs of the damage and collects other data pertinent to the property or vehicle. For example, the appraiser typically collects data pertaining to the vehicle identification number (VIN), the odometer, and the license plate of a vehicle to assess the damage to that vehicle. If real property is damaged, the appraiser typically collects data pertaining to the address, neighborhood, and condition of the property. The appraiser uses an estimating solution or database to provide a repair estimate that is based on the guidelines of the insurance carrier. Depending on either the damage or the professional performing the repair, the estimates compiled by the appraiser may further be analyzed by the insurer to evaluate the accuracy of the estimate.

As a consequence, an appraiser may expend multiple days or weeks to provide a complete estimate of damage. This lengthy process becomes costly and negatively affects the insurance claim process for both the insurer and the insured. For instance, this process is inefficient for the insured because they are required to schedule appointments with multiple professionals or an appraiser. Additionally, the rapidity in which an appraiser completes an estimate contributes to an increased length of time required to repair the damaged property or damaged vehicle. Long estimation cycles for vehicles cause insured customers to be without a vehicle for extended periods, which increases rental car costs for the insurer. Long estimation cycles on property can cause insured customers to be without use of their property for extended periods, which results in added costs associated with temporary living or other inconveniences. The process creates a bottleneck for the insurer because the appraiser remains occupied with the one claim as other claims continue to accumulate. In turn, the arduous process contributes to low customer satisfaction scores because of the inconvenience to insured customers.

Current systems and methods are in place to provide information related to vehicle or property damage to insurance carriers immediately after the damage occurs. These systems and methods are in place to assure that information is provided to an insurance carrier as quickly as possible in order to accelerate the claim process. Wireless devices, such as a smartphone, are commonly used to convey information to an insurance carrier. For example, U.S. Pat. No. 8,260,639 discloses the use of a mobile device to communicate information regarding an accident, such as driver's license number, contact information, and other identification, to an insurer claim system. An image analysis subsystem may analyze and process image data to determine the extent of damage for repair. U.S. Pat. Appl. Pub. No. 2002/0055861 discloses the use of a wireless device that has data capture capabilities, such as a camera to capture pictures of the damaged vehicle or VIN, or other information related to the accident. The pictures and information are sent to the insurer via a communication network. The insurer may use the data to contact a repairer or supplier. Similarly, U.S. Pat. Appl. Pub. No. 2010/0174564 discloses a method of providing the insurer with information from the insured via a mobile device. The insurer compiles vehicle history data to provide repair estimates to the insured.

Methods of claim processing that use wireless devices, such as smartphones, transmit information regarding a vehicular accident directly from insured to insurer. The current methods do not incorporate an intermediary claim manager to facilitate quick insurance claim processing and communications between the insured and insurer. An intermediary claim manager is beneficial in shortening the length of time taken to complete an estimate from multiple days or weeks to less than a few hours. Essentially, the insurance carrier is able to outsource much of its data collection and processing procedures. The insured can be any claimant that has an insurance policy with the insurer or any other claimant, such as a third-party beneficiary of the insured.

Presently, methods of using employees of the insurer to analyze the information provided by both applications on smartphones and image analysis are incredibly slow, inefficient, and costly. An intermediary claim manager is beneficial in shortening the length of time taken to complete an estimate, thereby reducing the cost to the insurer. It would be advantageous if methods of virtually processing insurance claims could be improved.

### SUMMARY OF THE INVENTION

Concordant and congruous with the present invention, a method of virtually processing insurance claims efficiently has surprisingly been discovered.

In an embodiment of the invention, a method of virtually settling insurance claims is disclosed. The method includes transmitting notice of damage to property of an insured to an insurer through a computer network; providing a claim assignment from the insurer to an intermediary claim manager through the computer network; providing the insured with an application through the computer network from the intermediary claim manager, the application configured to be downloaded on a device of the insured and facilitating the transmission of claim information to the intermediary claim manager through the computer network; transmission of claim information through the computer network to the intermediary claim manager for generating a claim assessment by the intermediary claim manager, the claim assessment including at least one settlement option for the insured; and transmitting the claim assessment through the computer network to the insurer.

In another embodiment of the invention, a method of virtually settling insurance claims includes transmitting notice of damage to property of an insured to an insurer through a computer network; providing a claim assignment from the insurer to an intermediary claim manager through the computer network, wherein the intermediary claim manager facilitates settling the insurance claims between the insured and the insurer; providing the insured with an application through the computer network from the intermediary claim manager, the application configured to be downloaded on a device of the insured and facilitating the transmission of claim information to the intermediary claim manager through the computer network; transmission of claim information through the computer network to the intermediary claim manager for generating a claim assessment by the intermediary claim manager, the claim assessment including at least one settlement option for the insured; transmitting the claim assessment through the computer network to the insurer; and employing the intermediary claim manager to administer the at least one settlement option chosen by the insured through the computer network.

In a further embodiment, a method of virtually settling insurance claims includes transmitting notice of damage to property of an insured to an insurer through a computer network; providing a claim assessment from the insurer to an intermediary claim manager through the computer network; employing the intermediary claim manager to provide the insured with an application through the computer network, the application configured to be downloaded on a device of the insured and facilitating the transmission of claim information to the intermediary claim manager through the computer network; transmission of claim information through the computer network to the intermediary claim manager for generating a claim assessment by the intermediary claim manager, the claim assessment including at least one settlement option for the insured; categorizing the claim information by the intermediary claim manager to facilitate generating the claim assessment; and employing the intermediary claim manager to administer the at least one settlement option to the insured from the insurer through the computer network.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic diagram of a method of virtually settling insurance claims according to an embodiment of the invention;

FIG. 2 is a flow diagram of the method of virtually settling insurance claims of FIG. 1.

### DETAILED DESCRIPTION OF EXEMPLARY EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

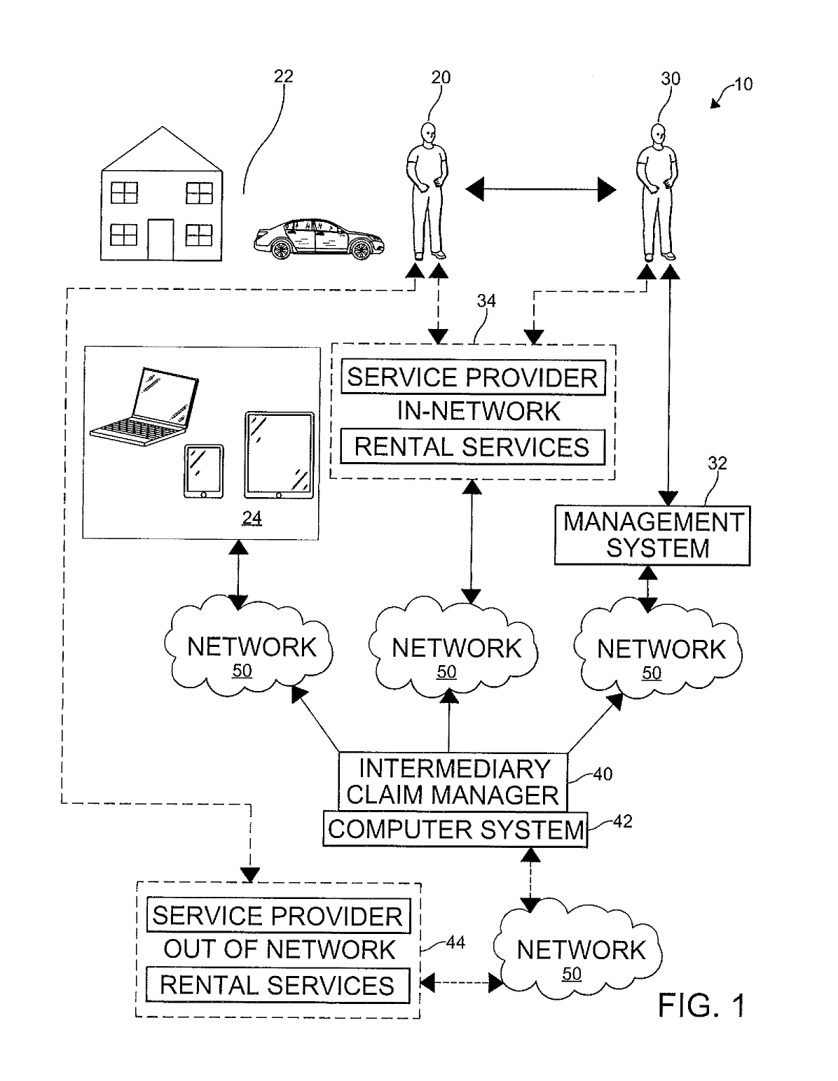

FIG. 1 illustrates a method 10 for virtually settling insurance claims using an intermediary claim manager 40 to facilitate claim processing, settlement, and communications between the insured 20 and the insurer 30. The insurer 30 is a person or company that provides insurance or contracts to compensate another, such as the insured 20, in the event of loss or damage to the insured 20. In particular embodiments, the insurer 30 can be a person or company that provides insurance in the event of loss or damage of property 22 of the insured 20 such as the non-limiting example of home insurance or vehicle insurance. However, it is understood that the insurer 30 can provide any type of insurance as desired. The insured 20 is any claimant that has an insurance policy with the insurer 30 or any other claimant such as a third-party beneficiary of the insured 20, for example. The insurer 30 can have a network of service providers 34 that contract with the insurer 30 to provide services to the insured 20 at pre-negotiated rates. The service providers 34 can be rental car providers, automobile repair shops, construction businesses, home inspection professionals, construction or vehicle suppliers, trade professionals, or other professionals or suppliers, as desired.

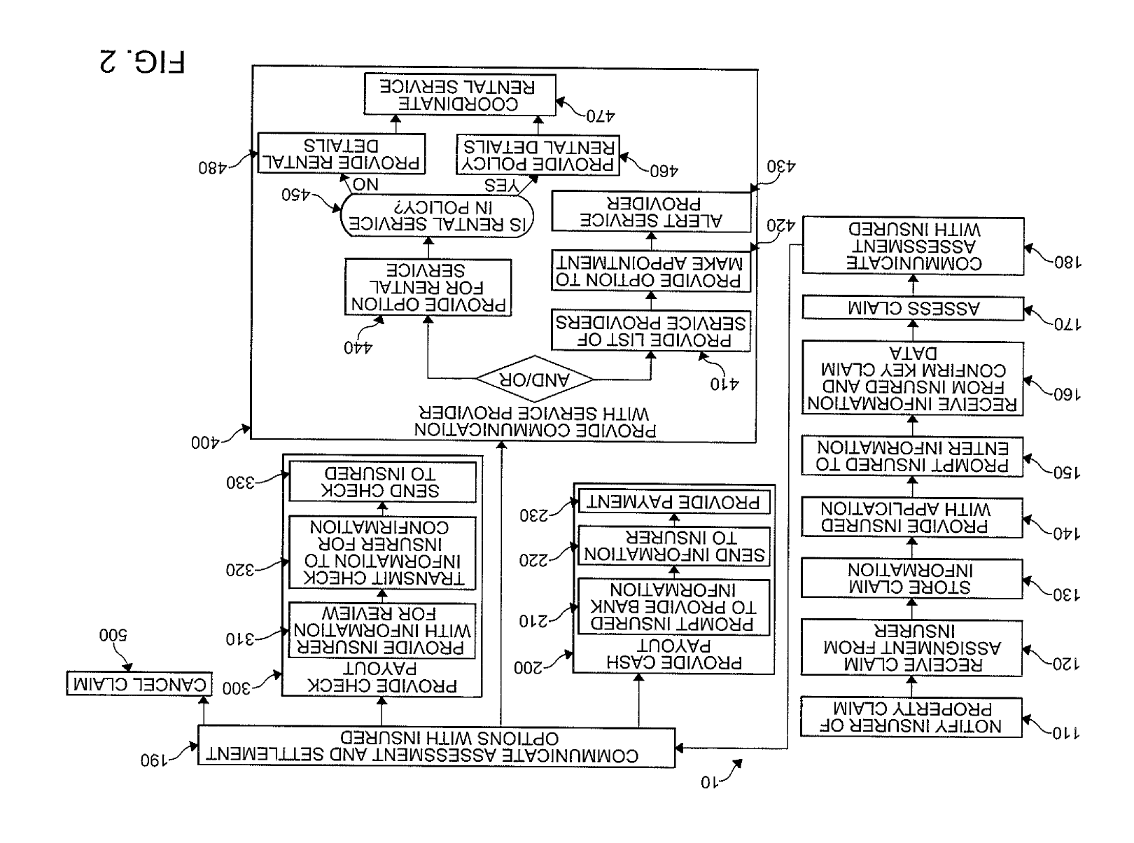

Referring to FIGS. 1 and 2, after an incident occurs which results in damage to the property 22 of the insured 20, the insured 20 contacts the insurer 30 to report the incident, as seen in step 110. The insurer 30 assigns a claim for payment through a management system 32. The management system 32 is a user interface such as a computer or other processor configured to permit the insurer 30 to store information and manage claims. The management system 32 can include an estimating system configured to estimate the amount of damage caused to the property 22 of the insured 20 such as the non-limiting examples of CCC brand estimating systems, MITCHELL brand estimating system, or AUDATEX brand estimating systems.

Referring to FIGS. 1 and 2, in step 120, an intermediary claim manager 40 receives the claim assignment from the insurer 30. The intermediary claim manager 40 acts as a liaison between the insured 20 and the insurer 30 to efficiently settle claims. In particular embodiments, the intermediary claim manager 40 is a computer system 42 with a server including at least a processor, memory, and database in communication with the management system 32 through a network 50 such as the internet or local network or any other computer network, as desired. For example, the claim is assigned to an intermediary claim manager 40 through the network 50 by a web portal software such as SNAPSHEET brand software. The software acts as an intermediary claim management system. However, it is understood that other computer networks and programs can also be used to assign a claim. The claim assignment can include information such as client information, claim policy information, policy number, VIN identification or address information, rental car or housing replacement policy, claim details, deductible amount, or similar information needed to facilitate settling a claim efficiently. In step 130, once the assignment is received by the intermediary claim manager 40, the claim information is stored with the intermediary claim manager 40 for claim confirmation. The information can be stored in a back-end portal of the web portal software.

As shown in step 140, once the claim is assigned and stored with the intermediary claim manager 40, the intermediary claim manager 40 provides the insured 20 with an application. The application is a software application that consists of a server that provides services such as data collection and distribution and is configured to be downloaded or otherwise integrated with a device 24. The application allows the insured 20 to communicate with the intermediary claim manager 40 via the network 50 and to view claim settlement information. In a non-limiting example, the application can be downloaded on a device 24 of the insured that is portable such as a web enabled mobile device, e.g. iPHONE or ANDROID smartphone. However, the application can be downloaded on any electronic device as desired such as a desk top computer, laptop computer, tablet, or any other mobile electronic device. The application can be branded with indicia of the insurer 30, such as trademark or trade name. In one embodiment, the application is provided to the insured 20 through the device 24 such as a smartphone. For example, the application can be sent by text message. The text message may contain a URL, link in the text that links the insured 20 to the application where the insured 20 is then prompted to download the application. The insured 20 could also receive the instructions for downloading the application by email or other data transfer measures such as accessing the application through a web application.

After the application is downloaded to the device 24, the application prompts the insured 20 to enter claim information, as shown in step 150. The application prompts the insured 20 to provide information related to the incident and the damages to the property 22. Information can include, in a non-limiting example, providing property 22 information, such as a YIN for vehicle damage or address for real property damage. In one embodiment of the invention involving a vehicle claim, the VIN can be entered manually by use of a keypad on the device 24. In another example, the VIN can be entered through a scanning function provided in the device 24. The scanning function allows the insured 20 to use their device 24 to scan the barcode on the VIN sticker in a vehicle. In another non-limiting example, a photo of the VIN can be sent by the insured 20 through the device 24 to the intermediary claim manager 40. The computer system 42 of the intermediary claim manager 40 then uses optical character recognition software that can scan photographs and automatically pull data into the computer system 42. The insured 20 is also prompted to take multiple photographs of the damaged property 22. The application can provide instructions to the insured 20 to indicate what pictures to take for insurance purposes. The instructions and photo capabilities may contain customizable text for user legibility. In one embodiment, the application can also prompt the insured 20 to provide a ten digit cell number and a pin.

As shown in step 160, the intermediary claim manager 40 receives the information and photographs inputted by the insured 20 through the application and confirms key claim data. The information is stored in the back-end portal of the web portal software for preparation of an assessment report. Once the information is sent to the intermediary claim manager 40, the application indicates to the insured 20 that an assessment report is being written. The assessment report may include information pertaining to total loss, repair estimate, or replacement cost, for example. The assessment report may also include options and/or recommendations to the insured 20 for further action. The insured 20 is unable to perform any functions through the application until the assessment report is prepared and notice to the insured 20 is indicated by an alert sent by the intermediary claim manager 40 through the application. However, it is understood that in another embodiment of the invention, the insured 20 is able to perform steps such as selecting a service provider 34, 44 while the assessment report is being prepared. The intermediary claim manager 40 compares and confirms key claim data such as the VIN or address provided by the insured 20 with the VIN or address provided by the insurer 30 in the back-end portal of the web portal software to correctly identify the insured 20. The photographs and other information provided by the insured 20 are appended to the claim information provided by the insurer 30 and stored in the hack-end portal. This step, 160, facilitates rapid claim processing.

In another step 170, the intermediary claim manager 40 assesses the claim. The claim can be assessed through the back-end portal of the web portal software. In one embodiment, the intermediary claim manager 40 may also receive the photos of the damaged property 22 and catalog the photos into categories such as damage severity. The categories and photos can be stored in the computer system 42 to allow the intermediary claim manager 40 to quickly select a claim assessment for property 22 with similar damage. In a non-limiting example, the damage can be categorized by area of the car for vehicle damage such as front end damage versus back end damage or a rating system can be used to categorize the damage. However, it is understood that the intermediary claim manager 40 can use other categorization as desired. This information will be used to create a prompt claim assessment instead of creating a new claim assessment. The intermediary claim manager 40 detects the claim information in a queue in the back-end portal of the web portal software and creates the assessment report. Claim management programs similar to those used by the insurer 30, such as CCC brand, MITCHELL brand, or AUDATEX brand management programs, can be integrated into the computer system 42 to provide a claim assessment. Once the claim is assessed, the claim assessment is added to the back-end portal to accompany the other claim information provided by the insurer 30 from the insured 20 during claim assignment.

The intermediary claim manager 40 communicates the claim assessment to the insurer 30 for approval as indicated in step 180. The claim assessment can be communicated to the insurer by transmitting the claim assessment through the network 50, for example, During communication of the claim assessment by the intermediary claim manager 40 to the insurer 30, the claim assessment is secured and cannot be altered. The intermediary claim manager 40 can convert the claim assessment into a printable report to facilitate efficient communication. For example, the intermediary claim manager 40 may create a report in a portable document format. However, it is understood that other document formats or word processing programs can be used for electronic document exchange.

Once the claim assessment is communicated to the insurer 30, the intermediary claim manager 40 communicates the claim assessment and provides settlement options to the insured 20, as shown in step 190. The intermediary claim manager 40 notifies the insured 20 that the claim assessment is approved and available to be viewed by the insured 20. In one embodiment, the intermediary claim manager 40 can use techniques to keep track of the status of claims. For example, the intermediary account manager 40 can change the claim status in the back-end portal to “sent” once it is approved by the insurer 30. In turn, a text message is sent to the device 24 or a push notification is sent through the application to alert the insured 20 of the claim assessment. After the insured 20 is notified, the insured 20 is directed to the claim assessment through the application. The insured 20 can email, text, print, or save the claim assessment to the device 24. The claim assessment will provide the insured 20 with various settlement options. In one embodiment, the settlement options include choosing a claim check payout, a claim cash payout such as an electronic funds transfer, automated clearing house or other wire transfer, choosing a service provider such as a repair shop or repair professional, or choosing to cancel the claim. However, it is understood that other options can be provided to the insured 20, as desired, such as providing other services such as a rental car service or temporary housing, choosing an inspector or estimator or expert, or providing any other information to the insured 20 to assist with the settlement of the claim.

In step 200, if the insured 20 chooses a cash payout, the intermediary claim manager 40 will provide the insured 20 with the cash payout. In one embodiment, the application will prompt the insured 20 to provide bank account and routing information, as shown in step 210. The insured 20 can manually enter the bank account and routing information manually through the device 24. Once the information is entered, the intermediary claim manager 40, in step 220, sends the information to the insurer 30 through the network 50 for approval. In step 230, an automatic payment by electronic funds transfer, automated clearing house, or wire transfer to the insured 20 will be made upon approval by the insurer 30. The intermediary claim manager 40 digitally transfers the payment through the network 50. In one embodiment of the invention, the intermediary claim manager 40 transfers funds through the network 50 to the insured 20. The intermediary claim manager 40 then bills the insurer 30. In another embodiment of the invention, the insurer 30 provides bank information of the insurer 30 to the intermediary claim manager 40. In this embodiment, the intermediary claim manager 40 transfers funds to the insured 20 from the bank of the insurer 30.

If the insured 20 chooses to take a check payout, the intermediary claim manager 40 will provide a check to the insured 20, as shown in step 300. The intermediary claim manager 40 will transmit check information provided by the insurer 30 to the insured 20 for review in step 310. In an embodiment of the invention, the intermediary claim manager 40 can automatically notify the insurer 30 of the address of the insured 20 through the network 50 If the address of the insured 20 changes the intermediary claim manager 40 alerts the insurer 30 through the network 50. This notification can be used to facilitate payout confirmation and militate against fraud. It is understood, that any information can be provided to the insurer 30 by the intermediary claim manager 40 through the network 50 to facilitate payout confirmation and militate against fraud such as desired. In step 320, the insured 20 can review the information, make any changes, and transmit the check information to the intermediary claim manager 40 through the application to be sent to the insurer 30 for review and confirmation. Once the information is confirmed by the insurer 30, a check can be sent to the insured 20, as shown in step 330. The check can be sent to the insured 20 by the insurer 30 or the check can be sent to the insured 20 by the intermediary claim manager 30.

In step 400, if the insured 20 chooses to select a service provider 34, 44, then the intermediary claim manager 40 will provide communication with the service provider 34, 44 such as a repair ship or repair professional. The service provider 34, 44 can be a service provider 34 within the network of service providers of the insurer 30 or can be a service provider 44 that is not within the network of service providers of the insurer 30. The intermediary claim manager 40 provides a list of service providers 34, 44 to the insured 20 as data in the application, as shown in step 410. In one embodiment, a list and viewable map of the closest service providers 34, 44 are provided through the application to the insured 20. The application on the device 24 allows the insured 20 to view photos of the service providers 34, 44, the address of the service providers 34, 44, and customer reviews of the service providers 34, 44. Other information can be provided as desired such as the rank of the service providers 34, 44 according to the intermediary claim manager 40 or recommendations from the insurer 30, and distance of travel to the service providers 34, 44 for the insured 20. The customer reviews can also be integrated from other sources from the network 50. Step 410 allows the insured 20 to compare and contrast the service providers 34, 44 and choose the service provider 34, 44 that would be most beneficial to the insured 20.

In step 420, the application can allow the insured 20 to make an appointment with the service provider 34, 44. If the insured 20 chooses to make an appointment, the insured 20 alerts the intermediary claim manager 40 of the choice through the application. In step 430, the intermediary claim manager 40 alerts the chosen service provider 34, 44 to communicate with the insured 20. The intermediary claim manager 40 can require that the service provider 34, 44 communicate with the insured 20 within a specified amount of time, such as 24 hours, for example, to confirm an appointment. However, any amount of time can be required as desired. The intermediary claim manager 40 can alert the service provider 34, 44 by any communication means desired such as by telephone, e-mail, or text message, for example. In one embodiment of the present invention, the intermediary claim manager 40 uses the computer system 42 to provide each of the service providers 34, 44 with a web portal through the network 50. The web portal allows the service providers 34, 44 to receive alerts and confirm appointments with the insured 20. The web portal also allows the service providers 34, 44 to confirm and modify their information that will be stored in the computer system 42 to be sent to the insured 20 through the application. The service provider 34, 44 can also append photographs through the web portal to be shown to the insured 20 through the application.

In one embodiment, the intermediary claim manager 40 provides an option for a rental car service for a claim involving vehicle damage, as shown in step 440. The option can be provided if the insured 20 has rental coverage in their claim policy. In step 450, the intermediary claim manager 40 will detect rental coverage in the policy through the information provided by the insurer 30 during claim assignment that is stored in the back-end portal of the web portal software. If rental car coverage is in the claim policy then the application will allow the insured 20 to view information such as pictures of cars in the class of cars that the rental coverage allows, as shown in steps 460 and 480. The insured 20 can then choose a rental car through the application. The intermediary claim manager 40 coordinates the rental car service for the insured 20, as shown in step 470. The intermediary claim manager 40 contacts the insurer 30 about the chosen rental car. The insurer 30 can be contacted through the management system 32 via the network 50 to alert the insurer 30 of the rental car chosen by the insured 20. After the insurer 30 is contacted, the rental car details can then be finalized by the insurer 30 contacting the insured 20. However, it is understood in an embodiment of the invention that the intermediary claim manager 40 can finalize and handle all details of the rental service for the insurer 30 and insured 20. In a non-limiting example, the intermediary claim manager 40 contacts the rental car service chosen by the insured 20 to arrange an appointment and provide payment to the rental car service from the insured 20 or insurer 30. The intermediary claim manager 40 can contact the rental car service by sending information to the rental car service through the network 50. A rental car service option can also be provided if the insured 20 does not have rental coverage in their policy. It is understood that any rental service can be included as an option for the insured 20 such as temporary housing or other property rental services for example. In one example, the computer system 42 can be integrated through the network 50 with rental services so that when an insured 20 chooses the rental service, an assignment is automatically sent to the rental service.

In step 500, if the insured 20 chooses to cancel the claim then the intermediary claim manager 40 cancels the claim. The intermediary claim manager 40 can alert the insurer 30 that the claim has been cancelled and no further action is taken.

From the foregoing description, one ordinarily skilled in the art can easily ascertain the essential characteristics of this invention and, without departing from the spirit and scope thereof, can make various changes and modifications to the invention to adapt it to various usages and conditions.

I claim:

1. A method of virtually settling insurance claims, comprising the steps of:
transmitting notice of damage to property of an insured to an insurer through a computer network;
providing a claim assignment from the insurer to an intermediary claim manager through the computer network;
providing the insured with an application through the computer network from the intermediary claim manager, the application configured to be downloaded on a device of the insured and facilitating the transmission of claim information to the intermediary claim manager through the computer network;
transmission of claim information through the computer network to the intermediary claim manager for generating a claim assessment by the intermediary claim manager, the claim assessment including at least one settlement option for the insured; and
transmitting the claim assessment through the computer network to the insurer.

2. The method of virtually settling insurance claims of claim 1, further comprising the step of employing the intermediary claim manager to administer the at least one settlement option chosen by the insured through the computer network.

3. The method of virtually settling insurance claims of claim 1, wherein the settlement option includes at least one of a cash payout, a check payout, an option to select a service provider, and an option to cancel the claim.

4. The method of virtually settling insurance claims of claim 3, wherein the settlement option is the cash payout including the step of facilitating an automatic payment from the insurer to the insured.

5. The method of virtually settling insurance claims of claim 3, wherein the settlement option is the check payout including the step of facilitating the issuance of a check from the insurer to the insured.

6. The method of virtually settling insurance claims of claim 3, wherein the settlement option is the option to select a service provider including the steps of facilitating communication between the service provider and the insured through the computer network and facilitating communication between the insurer and the insured regarding the service provider through the computer network.

7. The method of virtually settling insurance claims of claim 3, wherein the settlement option is the option to cancel the claim.

8. The method of virtually settling insurance claims of claim 1, wherein receipt of the claim assignment by the intermediary claim manager from the insurer through the computer network includes the step of receiving the claim assignment from a management system of the insurer through the computer network.

9. The method of virtually settling insurance claims of claim 1, wherein the device of the insured is a mobile electronic device.

10. The method of virtually settling insurance claims of claim 1, further comprising the step of the intermediary claim manager categorizing the claim information to facilitate generating the claim assessment.

11. A method of virtually settling insurance claims, comprising the steps of:
transmitting notice of damage to property of an insured to an insurer through a computer network;
providing a claim assignment from the insurer to an intermediary claim manager through the computer network, wherein the intermediary claim manager facilitates settling the insurance claims between the insured and the insurer;
providing the insured with an application through the computer network from the intermediary claim manager, the application configured to be downloaded on a device of the insured and facilitating the transmission of claim information to the intermediary claim manager through the computer network;
transmission of claim information through the computer network to the intermediary claim manager for generating a claim assessment by the intermediary claim manager, the claim assessment including at least one settlement option for the insured;
transmitting the claim assessment through the computer network to the insurer; and
employing the intermediary claim manager to administer the at least one settlement option chosen by the insured through the computer network.

12. method of virtually settling insurance claims of claim 11, wherein the settlement option includes at least one of a cash payout, a check payout, an option to select a service provider, and an option to cancel the claim.

13. The method of virtually settling insurance claims of claim 12, wherein the settlement option is the cash payout including the step of facilitating an automatic payment from the insurer to the insured.

14. The method of virtually settling insurance claims of claim 12, wherein the settlement option is the check payout including the step of facilitating the issuance of a check from the insurer to the insured,

15. The method of virtually settling insurance claims of claim 12, wherein the settlement option is the option to select a service provider including the steps of facilitating communication between the service provider and the insured through the computer network and facilitating communication between the insurer and the insured regarding the service provider through the computer network,

16. The method of virtually settling insurance claims of claim 12, wherein the settlement option is the option to cancel the claim.

17. The method of virtually settling insurance claims of claim 11, wherein receipt of the claim assignment by the intermediary claim manager from the insurer through the computer network includes the step of receiving the claim assignment from a management system of the insurer through the computer network.

18. The method of virtually settling insurance claims of claim 11, further comprising the step of the intermediary claim manager categorizing the claim information to facilitate generating the claim assessment.

19. A method of virtually settling insurance claims, comprising the steps of:
transmitting notice of damage to property of an insured to an insurer through a computer network;
providing a claim assessment from the insurer to an intermediary claim manager through the computer network;
employing the intermediary claim manager to provide the insured with an application through the computer network, the application configured to be downloaded on a device of the insured and facilitating the transmission of claim information to the intermediary claim manager through the computer network;
transmission of claim information through the computer network to the intermediary claim manager for generating a claim assessment by the intermediary claim manager, the claim assessment including at least one settlement option for the insured;
categorizing the claim information by the intermediary claim manager to facilitate generating the claim assessment; and
employing the intermediary claim manager to administer the at least one settlement option to the insured from the insurer through the computer network.

20. The method of virtually settling insurance claims according to claim 19, wherein the settlement option is at least one of a cash payout including the step of facilitating an automatic payment from the insurer to the insured, a check payout including the step of facilitating the issuance of a check from the insurer to the insured, an option to select a service provider including the steps of facilitating communication between the service provider and the insured through the computer network and facilitating communication between the insurer and the insured regarding the service provider through the computer network, and an option to cancel the claim.
